(19) United States
(12) Patent Application Publication
(10) Pub. No.: US 2020/0241474 A1
(43) Pub. Date: Jul. 30, 2020

(54) COPYING DEVICE AND METHOD FOR GENERATING A REPLICATION HOLOGRAM

(71) Applicant: Robert Bosch GmbH, Stuttgart (DE)

(72) Inventors: Moritz Kick, Stuttgart (DE); Reinhold Fiess, Durbach (DE)

(21) Appl. No.: 16/755,455

(22) PCT Filed: Sep. 20, 2018
(86) PCT No.: PCT/EP2018/075423

§ 371 Date: Apr. 10, 2020

(30) Foreign Application Priority Data
Oct. 18, 2017 (DE) 10 2017 218 545.7

(51) Int. Cl. G03H 1/20; G03H 1/04; G03H 1/12; G03H 1/22

(52) U.S. Cl. CPC G03H 1/20; G03H 1/0402; G03H 1/12; G03H 1/0476; G03H 1/2205; G03H 2227/04; G03H 2222/34; G03H 2222/42; G03H 2222/43; G03H 2001/0482; G03H 2223/16

(57) ABSTRACT

A copying device for generating a replication hologram that represents a copy of a master hologram. The device includes an object hologram for generating an object wave via a master signal, and a reference hologram for generating a reference wave with the aid of the master signal.

### FIELD

The present invention relates to a copying device for generating a replication hologram as a copy of a master hologram. Moreover, the present invention relates to a method for generating a replication hologram, using a copying device according to the present invention.

### BACKGROUND INFORMATION

For recording a hologram, it is generally conventional to initially separate a master signal into two coherent signals, using optical elements. One of the signals then impacts an object to be imaged, whose reflection forms an object wave. The second signal is used as a reference wave, and is brought into interference with the object wave on a photosensitive holographic layer. The resulting interference pattern is written into the holographic layer by exposure, as the result of which the relative phase shift between the reference wave and the object wave is recorded. The object wave may be reconstructed Aby then illuminating the interference pattern with the original reference wave. In addition to the three-dimensional imaging of objects, an optical function may also be fulfilled by use of a hologram. In this regard, a hologram may be made up of a plurality of subholograms (hogels), in this case the overall function of the hologram being determined from the different optical functions of all subholograms. It is thus possible to implement overall optical functions having a very complex design.

In addition, it is generally conventional to use holographic copying devices for replicating holograms. For example, a photosensitive layer is applied to the master hologram. The master hologram is then traversed area by area with a line scanner. In the process, the line scanner reproduces the original reference wave used in generating the master hologram. The reference wave transmits through the photosensitive layer and is diffracted at the master hologram, the reflection forming the object wave. Superimposing the generated object wave with the reference wave in the photosensitive layer results in a replication hologram as a copy of the master hologram. Such a copying method is limited to master holograms that have been formed by a simply designed reference wave, for example in the form of a spherical wave or a flat wave.

### SUMMARY

The copying device according to the present invention may have the advantage that the operation for copying a master hologram may be greatly speeded up. At the same time, the copying device according to the present invention allows cost advantages compared to the conventional copying devices for holograms in the related art, since according to the present invention, only one master signal is used when the replication hologram is generated as a copy of the master hologram. In particular, the copying device according to the present invention allows the operation for copying a master hologram, made up of a plurality of subholograms (hogels), to be speeded up, the number and/or the effect of anomalies contained in the master hologram also preferably being reduced.

This is made possible in that, for generating the replication hologram as a copy of the master hologram, the copying device according to the present invention includes a reference hologram that is excitable by a master signal and designed in such a way that after excitation with the master signal, the original reference signal of the master hologram is reproducible. In addition to the reference hologram, the copying device according to the present invention also includes an object hologram that is designed in such a way that an object wave is generatable upon excitation with the master signal. In other words, this means that the master signal is transformed by the reference hologram in such a way that a desired wave front is achieved, and the original reference wave is thus reproducible. At the same time, the master signal is transformed by the object hologram in such a way that here as well, a desired wave front is achieved which is likewise adapted to the original object wave. The object wave generated in this way and the reference wave generated in this way then meet one another in a plane in which a photosensitive layer for forming a replication hologram is situated, the interference pattern of the two waves being detected by the exposure of the photosensitive layer. According to the present invention, this allows the photosensitive layer to be formed as a copy of the replication hologram. This is based on the fact that according to the present invention, an appropriate object hologram and an appropriate master hologram are generated as a function of the master hologram, and are subsequently used by the copying device according to the present invention for replication of the master hologram. The object hologram and the reference hologram may be designed in such a way that they are excitable by a master signal having an arbitrary design. As a function of the power of the original source that is used for generating the master signal, either complete irradiation of the reference hologram and the object hologram is possible, or also a section-by-section traversal of the reference hologram and of the object hologram, optionally with the aid of optical elements for expanding the master signal, the generated object wave and the generated reference wave in the photosensitive layer overlapping to form the interference pattern section by section. The power of the original source may advantageously be designed to be lower, and thus more cost-effective. In this regard, the use of a line scanner is particularly preferred for section-by-section illumination.

According to the present invention, it is possible to use only one original source, the master signal being split by optical elements in order to irradiate the object hologram as well as the reference hologram for generating the object wave and the reference wave. Alternatively, however, two separate original sources may also be used for irradiating the object hologram and the reference hologram, in which case the master signals must have a mutually coherent design.

Advantageous refinements of the copying device according to the present invention are described herein.

In one preferred specific embodiment of the present invention, an original source is used which generates a master signal that includes a flat wave front or represents a spherical wave, or that also includes a cylindrical wave front. With all these master signals it is advantageous that the master signals may be generated relatively easily. Thus, for generating a master signal that includes a cylindrical wave front, the signal that is emitted by the original source need only be led through a cylindrical lens. The master signal generated in this way may then be used for complete or section-by-section illumination of the reference hologram and the object hologram. This allows cost advantages, since only cost-effective optical elements are needed for defining (forming) the master signal.

According to another preferred specific embodiment of the present invention, the master hologram includes at least two subholograms (hogels), the totality of the subholograms resulting in the optical function of the master hologram. In this regard, it is noted that each subhologram has its own optical function. It is thus possible to implement overall optical functions of the master hologram that are very complex and that cannot be implemented by conventional methods. According to the present invention, the object hologram and the reference hologram map the subholograms of the master hologram, in the copying device according to the present invention the irradiation of the reference hologram and of the object hologram during the copying operation also being possible independently of the subholograms. The copy of a master hologram made up of a million or more subholograms may thus be generated by the copying device according to the present invention. It is advantageous that, by use of the copying device according to the present invention, a copy of a master hologram formed in this way is possible with a single, unmodified master signal.

One refinement of the present invention provides that the object hologram and/or the reference hologram are/is situated in a glass plate and/or an optical fiber, preferably on the end side with respect to a light propagation direction. In this regard, it is further preferred when the glass plate on the input side includes a coupling hologram that is designed in such a way that the master signal is deflectable upon impacting the coupling hologram, and is thus propagated in a targeted manner within the glass plate or within the optical fiber in the direction of the object hologram and/or the reference hologram. For this purpose, the coupling hologram preferably forms deflection optical, the reference beam being diffracted so intensely that the master signal is reflected at an angle that is greater than the angle of the total reflection in the glass plate or the optical fiber. It is advantageous that the master signal may propagate within the optical fiber or the glass plate, and is thus led in a targeted manner to the end-side reference hologram or the object hologram. The object hologram situated on the end side and/or the reference hologram situated on the end side then fulfill(s) multiple functions. On the one hand, the deflection and alignment of the master signal on/with the photosensitive layer take place to form the interference pattern, and on the other hand the master signal in the reference hologram is transformed into the reference wave, and the master signal in the object hologram is transformed into the object wave. The coupling of the master signal into the glass plate or the optical fiber advantageously prevents the interference pattern being influenced or distorted by a scattering component of the master signal. In addition, the reference hologram and/or the object hologram may also be designed in such a way that a portion of the master signal is not deflected onto the photosensitive layer and further propagated within the glass plate or the optical fiber, and may thus be led away from the photosensitive layer in a targeted manner. In particular for generating replication holograms made up of numerous subholograms, such a procedure may be necessary for replicating individual subholograms, the result being improved by intentionally leading away a portion of the master signal.

One refinement of this specific embodiment provides that the object hologram and/or the reference hologram are/is designed in such a way that the propagation direction of the master signal is slightly varied during the deflection on and alignment with the photosensitive layer. Anomalies in the master hologram may be reduced and thus attenuated by this measure. In addition, transition points that necessarily result between the individual subholograms may be attenuated. In this regard, a replication hologram may advantageously be generated which has improved properties compared to the master hologram, since anomalies may be attenuated. Alternatively and/or additionally, the master signal may have a design that varies in the propagation direction, and thus propagates in various directions, preferably via an optical element. The master signal then impacts the object hologram and/or the reference hologram with scattering, so that the above-described effect may be achieved.

In one refinement of the present invention, it is also provided that the object wave and the reference wave impact the photosensitive layer from different sides in order to form the replication hologram there by exposure with the interference pattern. The proportion of scattering light beams may thus be advantageously reduced. At the same time, this advantageously allows the complete separation of the components necessary for generating the reference wave and the object wave.

One specific embodiment of the copying device formed in this way also allows manufacture that is suitable via mass production to be achieved by pushing the photosensitive layer through the copying device in a step-by-step manner. The generated object wave and the generated reference wave preferably impact the photosensitive layer in opposite directions to form the reference pattern.

In addition, the present invention also includes a copying method for generating a replication hologram by the copying device according to the present invention, the copying method according to the present invention including at least the following steps: a photosensitive layer is placed in a plane in a first step in order to form the replication hologram by exposure with an interference pattern from an object wave to be generated and a reference wave to be generated. A reference hologram is acted on with a master signal in a second step for generating the reference wave. At the same time, an object wave is generated by exciting an object hologram with the master signal, the object hologram and the reference hologram being situated and designed in such a way that the interference pattern is formed in the exact plane in which the photosensitive layer has been situated.

One refinement of the copying method according to the present invention provides that the master signal is optically transformed and aligned upon impacting the reference hologram in order to form the reference wave from the master signal. This advantageously allows the shape of the object wave and/or of the reference wave to be influenced, and the master signal to be arbitrarily adapted.

Lastly, the copying method also includes a method step in which the photosensitive layer is led step by step through the copying device according to the present invention, preferably in parallel to the above-mentioned glass plates that accommodate the reference hologram and the object hologram, a replication hologram preferably being generated in each step due to the exposure of the photosensitive layer with the interference pattern. Alternatively, it is also possible to generate only a portion of the replication hologram in each method step. In this regard, a complete replication hologram is formed only after a fixed number of method steps.

Further advantages, features, and particulars of the present invention result from the following description of exemplary embodiments and with reference to the figures.

### BRIEF DESCRIPTION OF THE DRAWINGS

FIG. 1 shows a schematic illustration of one preferred specific embodiment of the copying device according to the present invention, in a side view.

FIG. 2 shows a schematic illustration of one refinement of the copying device according to the present invention known from FIG. 1, likewise in a side view.

Functionally identical or equivalent elements and assemblies are denoted by the same reference numerals in the figures.

### DETAILED DESCRIPTION OF EXAMPLE EMBODIMENTS

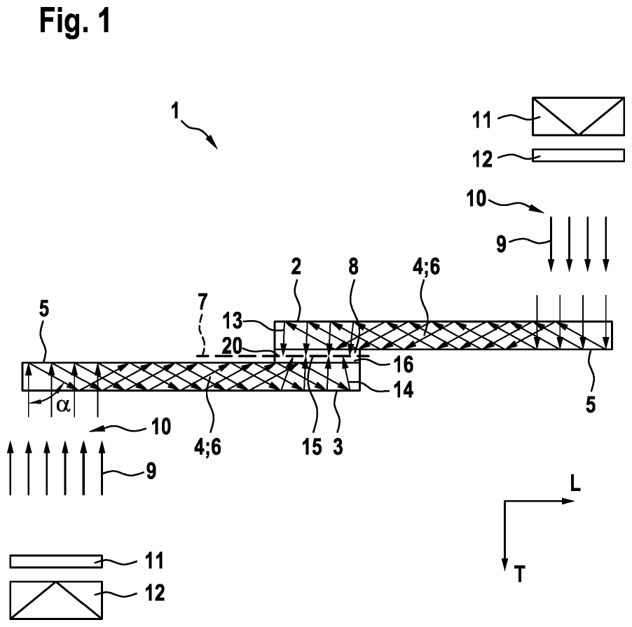

FIG. 1 shows a copying device 1 according to the present invention in one preferred specific embodiment of the present invention, in a side view. Copying device 1 according to the present invention includes an object hologram 2 and a reference hologram 3 that are spaced apart from one another along a depth axis T. Object hologram 2 on the end is situated in an optical fiber 6 designed as a glass plate 4, glass plate 4 extending along a longitudinal axis L. A coupling hologram 5 is situated (diagonally) in glass plate 4 in the end opposite from object hologram 2 with respect to longitudinal axis L. A photosensitive layer 8 is situated in the area of object hologram 2, between object hologram 2 and reference hologram 3, in a plane 7 parallel to longitudinal axis L. In addition, reference hologram 3 is situated in a waveguide 6 designed as a glass plate 4, glass plate 4 accommodating a coupling hologram 5 in an end opposite from reference hologram 3 along longitudinal axis L.

During operation, an original source 11, only schematically illustrated in FIG. 1, generates a master signal 9, which with the aid of an optical element 12 is converted into a master signal 9 that includes a flat wave front 10 and that is also aligned with one of the coupling holograms 5. Flat wave front 10 of master signal 9 thus impacts coupling hologram 5 situated in glass plate 4. Flat wave front 10 of master signal 9 is reflected at an angle a that is greater than the total reflection angle of glass plate 4. For this reason, flat wave front 10 of master signal 9 now propagates within glass plate 4 along longitudinal axis L in the direction of photosensitive layer 8, and at the end impacts either object hologram 2 or reference hologram 3. Reference hologram 3 now fulfills two functions: on the one hand, master signal 9 is deflected in the direction of photosensitive layer 8, and on the other hand is also optically transformed in such a way that master signal 9, which includes flat wave front 10, is converted into an original reference wave 14 of a master hologram, not graphically illustrated. In addition, a deflection of master signal 9 (alignment) and an optical transformation for reproducing original object wave 13 (formation) of the master hologram take place in object hologram 2. According to the present invention, object wave 13 and reference wave 14 are deflected and aligned in such a way that object wave 13 and reference wave 14 form an interference pattern 15 precisely in plane 7 in which photosensitive layer 8 has been situated, the interference pattern then being written into photosensitive layer 8 by exposure. This allows photosensitive layer 8 to form replication hologram 16, which forms the copy of the master hologram, it also being possible for replication hologram 16 to be made up of multiple subholograms (hogels) 20.

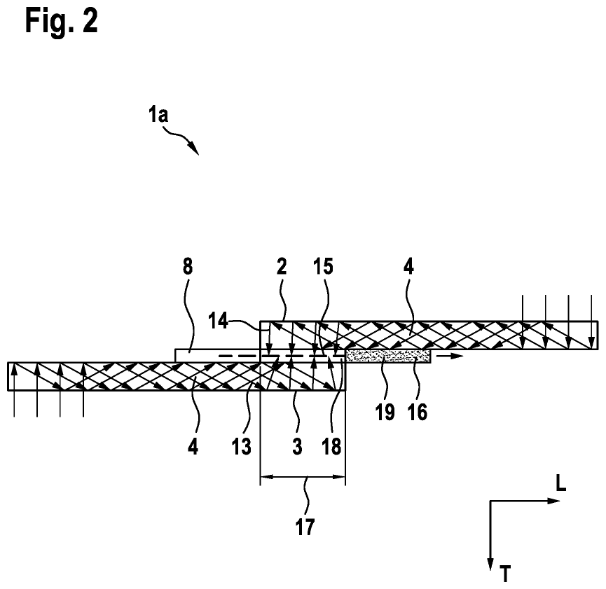

FIG. 2 shows a schematic illustration of copying device la according to the present invention in one preferred refinement of the present invention, in a side view. Illustrated copying device 1a differs from copying device 1 known from FIG. 1, in that photosensitive layer 8 now extends along longitudinal axis L between the two glass plates 4 that accommodate reference hologram 3 or object hologram 2. Photosensitive layer 8 is step-by-step displaceably situated along longitudinal axis L. This allows implementation of an advantageously simple automation of the copying operation by copying device la according to the present invention.

During operation, photosensitive layer 8 is initially situated between the two glass plates 4 along longitudinal axis L in such a way that a section 17 of photosensitive layer 8 is situated in a target position 18 in the area of object hologram 2 and reference hologram 3. Object wave 14 and reference wave 13 are subsequently generated according to the discussion for FIG. 1, as the result of which interference pattern 15 may be imparted by exposure in section 17 of photosensitive layer 8, and replication hologram 16 may thus be completely formed as a copy of the master hologram. After replication hologram 16 is generated, photosensitive layer 8 is displaced by a tracking increment along longitudinal axis L, as the result of which finished replication hologram 16 leaves target position 18 and is displaced into end position 19. A new section 17 of photosensitive layer 8 is now situated in target position 18, from which a replication hologram 16 is once again generatable.

In one alternative specific embodiment of the present invention, a curved surface on which photosensitive layer 8 is applied may also be inserted between glass plates 4. The desired optical function may thus be defined, even in an arbitrarily shaped hologram. This is meaningful, for example, when holograms are to be subsequently applied to eyeglasses. Due to the recording in a curved shape, it may be prevented that the holographic grating is distorted due to curvature after the recording, thus impairing the optical function.

In addition, it is noted that secondary to the illustrated specific embodiments, copying device 1; 1a may also have other designs without departing from the scope of the present invention.

1-10 (canceled)

11. A copying device for generating a replication hologram that represents a copy of a master hologram, the device comprising:
an object hologram configured to generate an object wave via a master signal; and
a reference hologram configured to generate a reference wave using the master signal, the object hologram and the reference hologram being configured in such a way that via irradiation with the master signal, the generated object wave intersects with the generated reference wave in a plane in which a photosensitive layer for forming the replication hologram, into which an interference pattern is writable by exposure, is situated.

12. The copying device as recited in claim 11, wherein the object hologram and/or the reference hologram, is excitable by a flat wave front as the master signal, or by a spherical wave as the master signal, or by a cylindrical wave front as the master signal.

13. The copying device as recited in claim 11, wherein the master hologram is made up of at least two subholograms that are generatable by reference waves that are originally different.

14. The copying device as recited in claim 11, wherein the object hologram and/or the reference hologram, is situated in on an end side in an optical fiber that is configured as a glass plate, the optical fiber including a coupling hologram that is configured in such a way that the master signal is deflectable in a direction of the object hologram and/or of the reference hologram.

15. The copying device as recited in claim 13, wherein the object hologram and/or the reference hologram is configured in such a way that the object wave and/or the reference wave is formed with a varying emission direction for reducing transition areas between the at least two subholograms of the replication hologram to be generated.

16. The copying device as recited in claim 11, wherein the photosensitive layer is situated for forming the replication hologram in such a way that the reference wave defined using the reference hologram and the object wave defined using the object hologram, impact on the photosensitive layer from opposite sides.

17. The copying device as recited in claim 11, wherein the photosensitive layer is configured to be pushed through the copying device step by step for creating a plurality of replication holograms.

18. A copying method for generating a replication hologram that represents a copy of a master hologram, the copying device including an object hologram configured to generate an object wave via a master signal, and a reference hologram configured to generate a reference wave using the master signal, the object hologram and the reference hologram being configured in such a way that via irradiation with the master signal, the generated object wave intersects with the generated reference wave in a plane in which a photosensitive layer for forming the replication hologram, into which an interference pattern is writable by exposure, is situated, the copying method comprising the following steps:
situating the photosensitive layer in the plane for forming the replication hologram by exposing the photosensitive layer with an interference pattern of the reference wave to be generated and the object wave to be generated;
irradiating the reference hologram with the master signal for generating the reference wave; and
simultaneously irradiating the object hologram for generating the object wave with the master signal.

19. The copying method as recited in claim 18, wherein the master signal in the reference hologram is transformed from the master signal to form the reference wave, and/or the master signal in the object hologram is transformed to form the object wave.

20. The copying method as recited in claim 18, wherein the photosensitive layer is pushed step by step through the copying device for forming the reference hologram as a copy of the master hologram for generating a plurality of replication holograms.
